(19) United States
(12) Patent Application Publication
(10) Pub. No.: US 2013/0306350 A1
(43) Pub. Date: Nov. 21, 2013

(54) TEMPERATURE RESISTANT HALOGEN FREE CABLE

(71) Applicant: NEXANS, (US)

(72) Inventors: Christof Dinkelmeyer, Lauf (DE); Frau Encarnacion Gonzales Calvo, Schwabach (DE); Uriel Fernando Munoz, Las Condes (CL); Luis Ernesto, Floridablanca-Santander (CO)

(21) Appl. No.: 13/713,184

(22) Filed: Dec. 13, 2012

(30) Foreign Application Priority Data
Dec. 15, 2011 (EM) 11 306 665.8

(51) Int. Cl. H01B 7/29; H01B 13/00; H01B 7/295

(52) U.S. Cl. CPC H01B 7/292; H01B 7/295; H01B 13/00
USPC 174/113 R; 29/825

(57) ABSTRACT

An electrical line with a temperature resistance of at most at least 90° C. and particularly fire properties which meet the Standard UL83 (corresponds to CSA Standard C22.2 No. 75-08) and are halogen free as a result, where the line has at least one electrical strand including a conductor and a flame retardant, temperature resistant halogen free insulating layer surrounding the conductor. The strand is surrounded by a casing of a polyamide containing polymer mixture, particularly of polyamide. The casing rests on the insulating layer of the strand or the line has an intermediate layer which forms an intermediate casing and borders the insulating layer of at least two strands and the casing which surrounds the intermediate layer and which is also called intermediate casing.

### RELATED APPLICATION

This application claims the benefit of priority from European Patent Application No. 11 306 665.8, filed on Dec. 15, 2011, the entirety of which is incorporated by reference.

### BACKGROUND

1. Field of the Invention

The present invention relates to a temperature resistant electrical line, particularly for use as an installation line in buildings, which may consist of an encased strand, or may have two, three or more strands in a casing.

The electrical line according to the invention is distinguished by the fact that it is temperature resistant, particularly up to 90° C., that it is halogen free, and meets the requirements of Standard UL83, particularly a maximum permissible temperature of use of 90° C., a high resistance to flame development and fire.

2. Description of Related Art

Single-strand lines of this type consist of a solid or stranded conductor, particularly aluminum or copper, on which rests a temperature resistant insulation layer of PVC, which is surrounded by a casing of a polyamide containing polymer mixture, in particular nylon.

U.S. Pat. No. 5,521,009 describes strands in which the conductor has an insulation layer of 20 to 80 phr or percent by weight ethylene propylene copolymer or another polyolefin, wherein the resistance to deformation or against foaming when heated can be increased by an addition of polyamide, polyphenylene sulfide, polybutylene terephthalate, polyethylene terephthalate, polyether ketone, and polyether ketone and polyether ether ketone as crystalline aromatic polymer or their mixtures. For increasing the heat resistance, 0.1-5 phr of a retarded phenol antioxidant can be added, particularly in order to increase the decomposition, foaming or deformation up to 200° C. for a short period of time. An insulation layer of polyamide is not provided. The flame resistance of the mixture is not discussed.

U.S. Pat. No. 5,358,786 describes an insulation layer for wires of 20 to 80 phr (percent by weight) polyolefin. For the flame resistance, an additional outer layer can be applied, in accordance with a second embodiment, around the insulated wire, while such a flame retardant layer of polyphenylene oxide, polyarylate, polyether ether ketone, and polyetherimide are indicated. The flame resistance of the mixture is not addressed.

WO 97/41569 describes strands insulated by means of polyolefin, a layer which may be of polyamide placed on the polyolefin, and an outer casing of polyvinylidene fluoride. It is mentioned that polyolefin ignites easily and that flame retardant ingredients negatively affect the electrical properties and physical properties of polyolefin.

### OBJECTS AND SUMMARY

It is the object of the invention to make available an electrical line, which has a similar or higher resistance to fire than lines whose strands have an insulation layer of PVC within a nylon casing, which has a maximum temperature resistance of at least 90° C. and is halogen free.

Further preferred, it should be possible to manufacture the layers which surround the conductor, at most, for the same costs as a conventional temperature and fire resistant halogen containing electrical line whose strands consist of a conductor with an insulation layer of PVC within a casing of nylon.

The invention meets this object with the features of the Claims, particularly with an electrical line with a maximum temperature resistance of at least 90° C. and particularly with fire properties which meet the Standard UL83 (corresponds to CSA Standard C22.2 No.75-08) and is halogen free as a result, has at least one electrical strand which consists of a conductor, especially solid or stranded aluminum or copper and a flame retardant, temperature resistant, halogen free insulation layer surrounding the conductor, wherein the strand is surrounded by a casing of a polyamide containing polymer mixture, particularly of polyamide. The casing rests on the insulation layer of the strand, or the line has an intermediate layer which forms an intermediate casing and borders the insulation layers of at least two strands and the casing which includes the in layer, which is also called intermediate casing.

The insulation layer of a strand consists of a halogen free polymer mixture which comprises or consists of
polyolefins, homopolymers and/or copolymers, particularly of propylene and/or ethylene units,
adhesion promoters, preferably polyolefin grafted with maleic acid, particularly with polyethylene grafted with maleic acid,
fillers, for example, chalk (calcium carbonate),
optionally silicon, in particular polydimethylsiloxane oil and/or polydimethylsiloxane rubber,
optionally a flame protection agent, preferably inorganic metal, hydroxide, such as aluminum hydroxide or magnesium hydroxide, an earth alkali salt and/or a salt of the zinc group, for example, selected from magnesium salt, calcium salt, strontium salt, barium salt, and zinc salt, wherein the salt is, in particular, the oxide or stearate, respectively, preferably selected from magnesium oxide, calcium oxide, and zinc oxide,
stabilizers, for example, phenolic anti-aging protection agents, and
processing aids, such as wax and/or paraffin.

Preferably, the polymer mixture of which the insulating layer of the strand consists, comprises or consists of
95 to 80 phr polyolefin, in particular 70 to 10 phr homopolyolefin, for example, polypropylene and/or polyethylene (LL, LD or MD), and 10 to 60 phr polyolefin copolymer, particularly of propylene units and ethylene units or ethylene vinyl acetate or ethylene butyl acrylate, in particular for a total of 100 phr,
5 to 20 phr polymeric adhesion promoter, in particular a polyolefin which contains functional groups, for example amine groups, amide groups or acid groups, wherein the polyolefin is preferably polyethylene and/or polypropylene, for example, polyethylene grafted with maleic acid,
filler as flame protection agent, particularly for 40 to 200 phr, for example, calcium carbonate and/or aluminum hydroxide,

optionally 2 to 15 phr silicon, in particular dimethylsiloxane oil and/or polydimethylsiloxane rubber,

optionally an inorganic salt, in particular an oxide of a two valent metal ion, for example, from the group comprising or consisting of calcium, magnesium, strontium, barium and zinc, for example, at 1 to 15 phr,

preferably a total of 0.1 to 20 phr stabilizers and processing aids.

The parts indicated in the mixtures are given as phr (parts per hundred rubber), i.e. the parts by weight of the components are indicated from 100 parts by weight organic polymer, selected from polyolefin and/or polyethylene. Therefore, phr correspond to percent by weight in relation to the content of organic cross linkable polymer.

The casing preferably consists of a second polymer mixture whose polymer component comprises or consists of, polyamide, preferably with a composition which comprises or consists of
polyamide 6 (PA6), polyamide 4 (PA4) and/or polyamide 12 (PA12),
optionally flame protection agent, for example, melamine cyonurate at 0 to 30 phr,
optionally stabilizers, such as, for example, phenolic antioxidants at 0 to 5 phr.

This polyamide containing polymer mixture may consist of polyamide, particularly PA6, PA4 and/or PA12, to which optionally flame protection agent, processing aids and/or stabilizers are added.

The electrical line according to the invention preferably has the mechanical properties and fire properties which are defined in Standard UL83 for THHN lines with a casing of polyamide (particularly nylon).

Alternatively or additionally, the insulation layer of the strand, when stored in air of 97±1° C. for at least twelve weeks, at most 36 weeks, at least during the last 6 weeks of storage at increased temperature, should be 3 GΩm or more, particularly for use as installation line in surroundings up to at most at least 90° C. Preferably, during the storage at 97±1° C. and/or while measuring the resistance of the insulation layer, a voltage of 600 volts rms is applied.

Preferably, the electrical line according to the invention is not damaged at room temperature after aging at 136° C. in the convection oven for seven days, particularly no cracks after winding onto a coil in accordance with Standard UL83. In addition, after this aging, the tensile strength is at least 75% of the initial value, and/or the elongation at rupture is at least 65% of the initial value.

Preferably, the line according to the invention has, in the deforming test according to UL83 at 136±1° C., a maximum decrease of the thickness of 30% under load.

In particular, the line according to the invention has a flame and fire resistance according to UL83, particularly such that the flames, after use of a test flame five times for 15 s each with interruptions of 15 s each, expire again within 60 s or, that after the use of the test flame, no more flames are present after 60 s, and particularly without dripping of material which could ignite a cotton cloth arranged underneath the line.

The line according to the invention may have a single strand or may consist of a conductor, the insulating layer surrounding the conductor, and a casing of: a polyamide containing polymer mixture which rests on the insulating layer.

Alternatively, the electrical line may consist of two or more strands, each of which has an insulation layer surrounding the conductor, within a casing of a polyamide containing polymer mixture surrounding the strands.

In an embodiment, the electrical line may consist of two, three or more strands whose insulating layers, each surrounded by a separate directly placed polyamide containing polymer mixture, are contained in a common casing of a temperature resistant, halogen free polymer mixture according to the invention. In this embodiment it is preferred that the insulating layer of each strand has the same composition as the temperature proof, halogen free polymer mixture within which the strands are contained with their respective casings of a polyamide containing polymer mixture. Optionally, an additional outer casing of a polyamide containing polymer mixture may be placed on the temperature proof, halogen free polymer mixture which has, at the two or more strands, a conductor each, an insulating layer each and a casing each placed on the insulating layer of a polyamide containing polymer mixture.

In another embodiment, the line according to the invention may have two, three or more strands, each of which consist of a conductor and an insulating layer of a temperature proof, halogen free polymer mixture surrounding the conductor, an intermediate layer which surrounds the strands and consists of a temperature proof, halogen free polymer mixture, and may have or consist of an outer casing placed on the intermediate layer of a polyamide containing polymer mixture.

### BRIEF DESCRIPTION OF THE DRAWINGS

In the Figures identical reference numerals refer to functionally equivalent elements.

FIG. 1 shows a single-strand line in accordance with one embodiment;

FIG. 2 shows a line with a plurality of strands in accordance with one embodiment;

FIG. 3 shows a three strand line in accordance with one embodiment; and

FIG. 4 shows a three strand line as in FIG. 3, in accordance with another embodiment.

### DETAILED DESCRIPTION

Preferred embodiments of cables have, for example, at least one strand with an insulation of the conductor of a mixture according to the invention (HFFR), and an intermediate layer of polyamide (PA), and a casing of a mixture according to the invention based on polyolefin (HFFR),

at least one strand with an insulation of the conductor of: a mixture according to the invention (HFFR), an intermediate layer of polyamide (PA) and a casing of polyamide (PA),

at least one strand with an insulation of the conductor of a mixture according to the invention (HFFR), an intermediate layer of polyamide (PA) and a two-layer casing of an intermediate layer of the mixture according to the invention with an outer layer of polyamide (HFFR/PA) placed thereon, or

at least one strand with an insulation of the conductor of a mixture according to the invention based on polyolefin (HFFR) with a two-layer casing of an intermediate layer of a mixture according to the invention with an outer layer of polyamide (HFFR/PA) placed thereon, or consists thereof.

The advantageous properties of the halogen free mixture (HFFR), according to the invention, are demonstrated in the following tables for electrical lines having one strand whose insulation consists of HFFR (HFFR 1 and HFFR 2) or of PVC for comparison, with a casing of polyamide.

The mixture HFFR 1 consists of:

| | phr |
|---|---|
| polyethylene, grafted with | 10 |
| maleic acid anhydride | |
| polyolefin elastomer | 60 |
| polypropylene | 30 |
| phenolic anti-aging agent | 1.0 |
| metal deactivator | 1.0 |
| UV protective agent | 1.0 |
| magnesium stearate | 6.0 |
| calcium carbonate | 50 |
| silicon oil | 7.0 |

and the mixture HFFR 2 consists of:

| | phr |
|---|---|
| Polyethylene LL | 60 |
| Polyolefin elastomer | 33 |
| polyethylene, grafted with | 7 |
| maleic acid anhydride | |
| aluminum hydroxide | 160 |
| lubricant | 5 |
| Phenolic anti-aging agent | 3 |
| Metal deactivator | 2 |

TABLE 1
Comparison of the Mechanical Properties of Lines
with Insulating Layers of the Strands of PVC (Comparison)
or HFFR (according to the invention)

| Property | Unit | Goal | HFFR 1 | HFFR 2 | PVC |
|---|---|---|---|---|---|
| Tensile strength (min) | MPa | 13.8 | 16.9 | 19.8 | 18.8 |
| Elongation at rupture (min) | % | 150 | 700 | 236 | 250 |
| Tensile strength after | % | 75 | 98 | 121 | 120 |
| aging (136° C./7 d) (min) | | | | | |
| Elongation at rupture after | % | 65 | 98 | 97 | 75 |
| aging (136° C./7 d) (min) | | | | | |

TABLE 2
Comparison of the Flame Resistance and Temperature Resistance of
Lines of PVC (comparison) or HFFR (according to the invention)

| Property | Test | Goal | HFFR 1 | HFFR 2 | PVC |
|---|---|---|---|---|---|
| FV-1 (Cotton) | passed | passed | passed | passed | passed |
| Smoke density | IEC 61034 | >60% | 93% | 96% | <60% |
| Corrosiveness of | IEC 60754 | >4.3 | 7.5 | 7.7 | <4.3 |
| the fire gasses | | | | | |
| pH Value | | <10 | 5.5 | 8.3 | >10 |
| Conductivity, | | | | | |
| μS/min | | | | | |

This data shows that the halogen free polymer mixture according to the invention provides the lines with sufficiently high mechanical strength values and good fire resistance and temperature properties, in particular, develops less smoke and the fire gasses have a significantly lower corrosiveness.

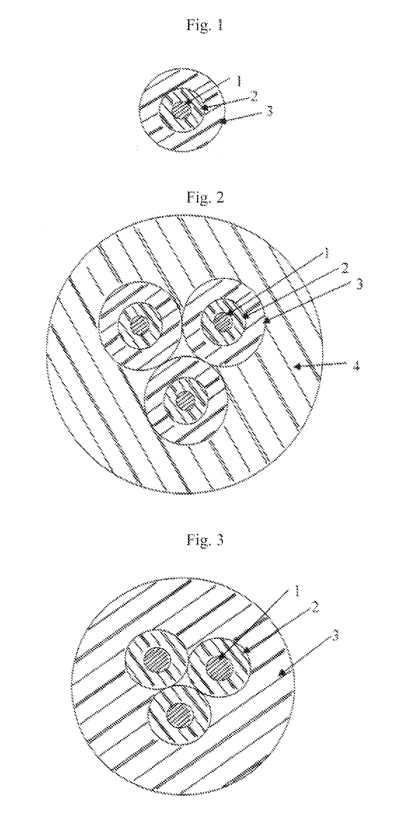

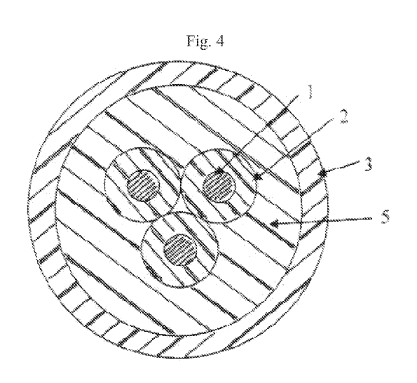

The invention will now be described in more detail with reference to the Figures which schematically show
a single strand line in FIG. 1,
a three strand line in FIG. 2,
another embodiment of a three strand line in FIG. 3, and
another embodiment of a three strand line in FIG. 4.

In the Figures identical reference numerals refer to functionally equivalent elements.

FIG. 1 shows a single-strand line which comprises a strand and a casing 3 of a polyamide containing polymer mixture, wherein the strand consists of a metal conductor 1 and an insulating layer 2 of a temperature proof halogen free polymer mixture.

An embodiment of: the line with a plurality of strands is shown in FIG. 2, wherein the three strands, which each consist of a conductor 1, an insulating layer 2 of a temperature proof halogen free polymer mixture and, placed thereon, a casing layer 3 of a polyamide containing polymer mixture, wherein the three strands are surrounded by a common casing 4 of a temperature proof halogen free polymer mixture. As generally preferred, the temperature proof halogen free polymer mixture, which forms the common casing 4 of a temperature proof halogen free polymer mixture, has a composition which is identical to the temperature proof halogen free polymer mixture which forms the insulating layer 2.

An embodiment of a three strand line is illustrated in FIG. 3 in which three strands, which each consist of the conductor 1 and an insulating layer 2 of a temperature proof halogen free polymer mixture, are surrounded by a common casing 3 of a polyamide containing polymer mixture. Preferably the line of this embodiment consists of the strands and a casing 3 of a polyamide containing polymer mixture surrounding the strands. In this embodiment, the casing 3 of a polyamide containing polymer mixture rests on three strands, each of which consists of a conductor 1 and an insulating layer 2 of a temperature proof halogen free polymer mixture.

In accordance with a further development of the embodiment shown in FIG. 3, FIG. 4 shows an embodiment of the line according to the invention with three strands which each are comprised of a conductor 1 within an insulating layer 2 of a temperature proof halogen free polymer mixture, and are surrounded by a common casing 3 of a polyamide polymer mixture, wherein, between the casing of the polyamide containing polymer mixture and the strands, an intermediate casing 5 as an intermediate layer of a temperature proof halogen free polymer mixture is arranged, wherein the intermediate casing borders on the insulating 2 of the strands on the one hand, and on the outer casing on the other hand.

In the embodiments shown in FIGS. 2 and 4 the insulating layers 2 of the strands and the casing 4, or the intermediate casing 5 as an intermediate layer, are preferably of the same temperature proof halogen free polymer mixture.

### LIST OF REFERENCE NUMERALS

1 Conductor
2 Insulating layer
3 Casing of polyamide containing polymer mixture
4 Outer casing of temperature proof halogen free polymer mixture
5 Intermediate casing of temperature proof halogen free polymer mixture

1. Electrical line with a temperature resistance of up to at least 90° C., comprising:
at least one electrical strand which has a metal conductor and a flame resistant, temperature resistant insulating layer, surrounding the conductor (1), wherein the strand is surrounded by a casing of a polyamide containing polymer mixture, resting on the material, of the flame resistant insulating layer,
wherein the insulating layer surrounding the conductor includes a flame retardant, temperature resistant halogen free polymer mixture whose polymer component are polyolefins,
wherein the flame retardant, temperature resistant halogen free polymer mixture includes
95 to 80 phr polyolefin,
5 to 20 phr polymer adhesion promoter
40 to 200 phr filler selected from the group consisting of calcium carbonate and/or aluminum hydroxide and/or magnesium hydroxide,
0 to 15 phr silicon
0 to 15 phr of either one of an oxide or a stearate of a two-valent metal ion selected from the group consisting of calcium, magnesium, strontium, barium and zinc, and
0.1 to 2 phr stabilizers and processing aids.

2. Electrical line according to claim 1, wherein the casing of a polyamide containing polymer mixture, rests on the insulating layer, which surrounds a conductor each

3. Electrical line according to claim 1, wherein at least two strands which each include a conductor and a temperature resistant insulating layer, are surrounded by a common casing which has a flame retardant, temperature resistant halogen free polymer mixture which forms an outer casing, wherein the flame retardant, temperature resistant halogen free polymer mixture includes
95 to 80 phr polyolefin,
5 to 20 phr polymer adhesion promoter
40 to 200 phr filler selected from the group consisting of calcium carbonate and/or aluminum hydroxide and/or magnesium hydroxide,
0 to 15 phr silicon
0 to 15 phr of either one of an oxide or a stearate of a two-valent metal ion selected from the group consisting of calcium, magnesium, strontium, barium and zinc, and
0.1 to 20 phr stabilizers and processing aids.

4. Electrical line according to claim 1, wherein the line includes at least one strand and the casing of a polyamide containing polymer mixture resting on the insulating layer.

5. Electrical line according to claim 1, wherein at least two strands, each of which includes a metal conductor and a respective insulating layer of a flame retardant, temperature resistant halogen free polymer mixture surrounding the conductor, and a casing of a polyamide containing polymer mixture surrounding each of the strands, and an outer casing of a temperature proof halogen free polymer mixture resting on the casing.

6. Electrical line according to claim 1, wherein at least two strands, each of which includes an electrical conductor with a flame retardant, temperature resistant halogen free insulating layer surrounding the conductor, wherein the strands are surrounded by an intermediate casino resting on the insulating layer, wherein the intermediate casing includes a flame retardant, temperature resistant halogen free polymer mixture, and an outer casing of a polyamide polymer mixture rests on the intermediate casing.

7. Electrical line according to claim 1, wherein the polyolefin includes 70 to 10 phr polypropylene and/or polyethylene and 10 to 60 phr polyolefin copolymer, of propylene units and/or ethylene units, and/or ethylene vinyl acetate or ethylene butyl acrylate, and the polymer adhesion promoter is a polyethylene grafted with maleic acid.

8. Electrical line according to claim 1, wherein the polymer of the polyamide containing polymer mixture 100 phr is polyamide.

9. Electrical line according to claim 8, wherein the polyamide containing polymer mixture contains a flame protecting agent.

10. Electrical line according to claim 9, wherein the flame protecting agent is melamine cyanurate.

11. A method for applying electrical lines to a building, said method comprising the step of:
Installing at least one electrical line according to claim 1.
